(19) United States
(12) Patent Application Publication
(10) Pub. No.: US 2023/0238000 A1
(43) Pub. Date: Jul. 27, 2023

(54) ANONYMIZING SPEECH DATA

(71) Applicant: Ford Global Technologies, LLC, Dearborn, MI (US)

(72) Inventors: David Michael Herman, West Bloomfield, MI (US); Alexander George Shanku, Grosse Pointe Park, MI (US)

(73) Assignee: Ford Global Technologies, LLC, Dearborn, MI (US)

(21) Appl. No.: 17/585,860

(22) Filed: Jan. 27, 2022

(51) Int. Cl. G10L 15/26; G10L 15/22; G10L 25/18

(52) U.S. Cl. CPC G10L 15/26; G10L 15/22; G10L 25/18; G10L 2015/223

(57) ABSTRACT

A computer includes a processor and a memory, and the memory stores instructions executable by the processor to receive first speech data, remove a first vector of speaker-identifying characteristics from the first speech data to generate extracted first speech data, generate a random vector of the speaker-identifying characteristics, and generate second speech data by applying the random vector to the extracted first speech data.

### BACKGROUND

Many modern vehicles include voice-recognition systems. Such a system includes a microphone. The system converts spoken words detected by the microphone into text or another form to which a command can be matched. Recognized commands can include adjusting climate controls, selecting media to play, etc.

### BRIEF DESCRIPTION OF THE DRAWINGS

FIG. 1 is a block diagram of an example vehicle.

FIG. 2 is a representation of example speech data.

FIG. 3 is a diagram of an example collection of machine-learning programs for anonymizing speech data.

FIG. 4 is a process flow diagram of an example process for anonymizing the speech data.

### DETAILED DESCRIPTION

The system and techniques described herein can anonymize speech data. Anonymizing the speech data may prevent voice-identification systems from identifying the speaker based on analyzing the speech. Specifically, the system can receive first speech data, remove a first vector of speaker-identifying characteristics from the first speech data to generate extracted first speech data, generate a random vector of the speaker-identifying characteristics, and generate second speech data by applying the random vector to the extracted first speech data. The second speech data is thus anonymized. Moreover, the system can preserve nonidentifying characteristics of the speech data such as content and voice style, e.g., tempo, volume, pitch, accent, etc.

A computer includes a processor and a memory, and the memory stores instructions executable by the processor to receive first speech data, remove a first vector of speaker-identifying characteristics from the first speech data to generate extracted first speech data, generate a random vector of the speaker-identifying characteristics, and generate second speech data by applying the random vector to the extracted first speech data.

The instructions may further include instructions to determine text from the first speech data. The instructions may further include instructions to remove at least one segment of the first speech data based on the text of the at least one segment being in a category. Generating the second speech data may occur after removing the at least one segment of the first speech data.

The category may be personally identifiable information.

The instructions may further include instructions to transmit the second speech data to a remote server. The instructions may further include instructions to transmit the random vector to the remote server.

The first speech data may include a voice command. The instructions may further include instructions to actuate a component of a vehicle based on the voice command.

Generating the random vector may include sampling from distributions of the speaker-identifying characteristics. The distributions may be derived from measurements of the speaker-identifying characteristics from a population of speakers.

The first vector may include a spectrogram. The spectrogram may be a mel-spectrogram.

Removing the first vector from the first speech data may include encoding the first speech data without the first vector to generate the extracted first speech data. The first speech data without the first vector may include executing a machine-learning program. The machine-learning program may be a convolutional neural network using downsampling.

Applying the random vector to the extracted first speech data may include decoding the extracted first speech data using the random vector. Decoding the extracted first speech data may include executing a machine-learning program. The machine-learning program may be a convolutional neural network using upsampling.

A method includes receiving first speech data, removing a first vector of speaker-identifying characteristics from the first speech data to generate extracted first speech data, generating a random vector of the speaker-identifying characteristics, and generating second speech data by applying the random vector to the extracted first speech data.

With reference to the Figures, wherein like numerals indicate like parts throughout the several views, a computer 102 in a vehicle 100 includes a processor and a memory, and the memory stores instructions executable by the processor to receive first speech data 104, remove a first vector 105 of speaker-identifying characteristics from the first speech data 104 to generate extracted first speech data 106, generate a random vector 108 of the speaker-identifying characteristics, and generate second speech data 110 by applying the random vector 108 to the extracted first speech data 106.

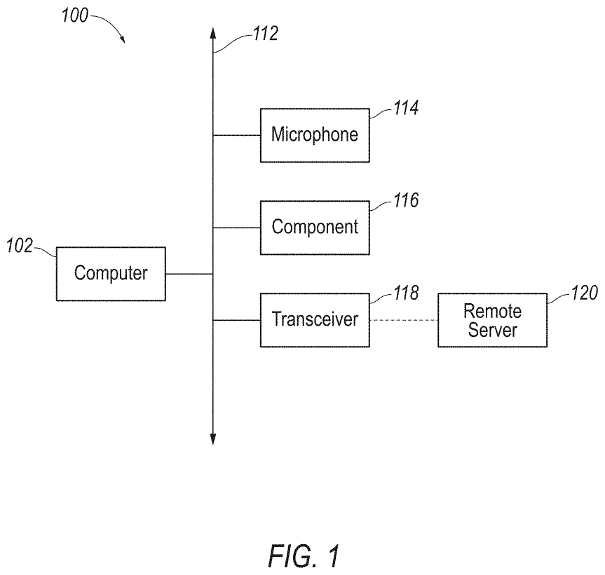

With reference to FIG. 1, the vehicle 100 may be any passenger or commercial automobile such as a car, a truck, a sport utility vehicle, a crossover, a van, a minivan, a taxi, a bus, etc.

The computer 102 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 102 can thus include a processor, a memory, etc. The memory of the computer 102 can include media for storing instructions executable by the processor as well as for electronically storing data and/or databases, and/or the computer 102 can include structures such as the foregoing by which programming is provided. The computer 102 can be multiple computers coupled together.

The computer 102 may transmit and receive data through a communications network 112 such as a controller area network (CAN) bus, Ethernet, WiFi, Local Interconnect Network (LIN), onboard diagnostics connector (OBD-II), and/or by any other wired or wireless communications network. The computer 102 may be communicatively coupled to a microphone 114, a component 116 of the vehicle 100 activatable by voice command, a transceiver 118, and other components 116 via the communications network 112.

The microphone 114 is a transducer that converts sound to an electrical signal. The microphone 114 can be any suitable type, e.g., a dynamic microphone, which includes a coil of wire suspended in a magnetic field; a condenser microphone, which uses a vibrating diaphragm as a capacitor plate; a contact microphone, which uses a piezoelectric crystal; etc.

The component 116 is able to be activated by a voice command from an occupant of the vehicle 100 (or from a user if the computer 102 is not installed on board the vehicle 100), as will be described below. The component 116 can be, e.g., a media entertainment system, a telephone-control system (e.g., that synchronizes with a mobile device of the occupant that has cellular capabilities), a climate-control system, etc. A media entertainment system can include a radio and can include a synchronized mobile device that can play stored or streaming audio files. A telephone-control system can place and receive calls via the synchronized mobile device. A climate-control system can control heating and cooling of a passenger cabin of the vehicle 100.

The transceiver 118 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 118 may be adapted to communicate with a remote server 120, that is, a server distinct and spaced from the vehicle 100. The remote server 120 may be located outside the vehicle 100. For example, the remote server 120 may be associated with another vehicle (e.g., V2V communications), an infrastructure component (e.g., V2I communications), an emergency responder, a mobile device associated with the owner or operator of the vehicle 100, a cloud server associated with a manufacturer or fleet owner of the vehicle 100, etc. The transceiver 118 may be one device or may include a separate transmitter and receiver.

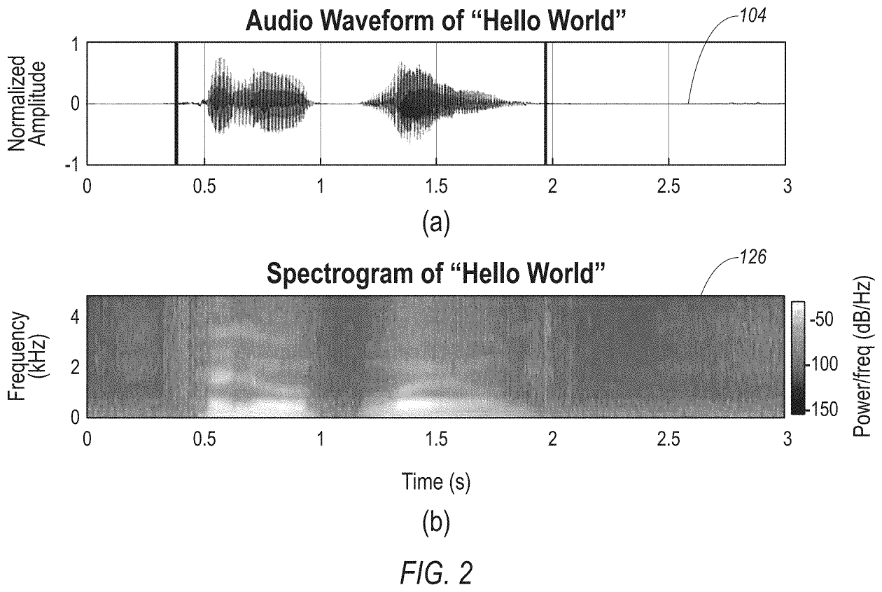

With reference to FIG. 2, the computer 102 can be programmed to receive the first speech data 104 of speech spoken by the occupant. For the purposes of this disclosure, “speech data” is defined as data from which audio of speech can be played. The first speech data 104 can be stored in a standard audio file format such as .wav.

The first speech data 104 can be any utterance captured in a vehicle 100, e.g., can include a voice command for the component 116, e.g., “Call Pizza Place,” “Play Podcast,” “Decrease Temperature,” etc. The computer 102 can be programmed to identify the voice command from the first speech data 104, e.g., by converting to text as will be described below or by known pattern-recognition algorithms. The computer 102 can be programmed to actuate the component 116 based on the voice command, e.g., respectively for the example voice commands, by instructing the mobile device of the occupant to initiate a phone call by the telephone-control system, playing an audio file from the mobile device by the media entertainment system, increasing air conditioning or decreasing heating by the climate-control system, submitting an error report to the remote server 120, which may be associated with a manufacturer of the vehicle 100, etc.

The computer 102 can be programmed to determine text from the first speech data 104. The computer 102 can use any suitable algorithm for converting speech to text, e.g., hidden Markov models, dynamic time warping-based speech recognition, neural networks, end-to-end speech recognition, etc.

The computer 102 can be programmed to remove segments of the first speech data 104 based on the text, e.g., in response to some or all of the text being in a category. For example, the category can be personally identifiable information (PII). For the purposes of this disclosure, “personally identifiable information” is defined as a representation of information that permits the identity of an individual to whom the information applies to be reasonably inferred, such as names, phone numbers, addresses, etc. The computer 102 can be programmed to remove segments of the first speech data 104 that have text in the category, resulting in redacted first speech data 104. For the purposes of this disclosure, a “segment” is a portion of speech data defined by a finite interval of time. For example, the computer 102 can remove a segment starting 5 seconds into the first speech data 104 and ending 7 seconds into the first speech data 104, e.g., by deleting that segment or overwriting that segment as silence. Generating the second speech data 110, described below, can occur after removing the segments from the first speech data 104. In other words, the description below for generating the second speech data 110 can use the redacted first speech data 104 as input rather than the unredacted first speech data 104. Alternatively, generating the second speech data 110 can occur without removing the segments from the first speech data 104, i.e., by using the unredacted first speech data 104 as input. For example, generating the second speech data 110 can use the unredacted first speech data 104 as input instead of the redacted first speech data 104 in response to a message from the remote server 120 instructing the computer 102 to do so. For example, the remote server 120 may use the second speech data 110 generated using the unredacted first speech data 104 to analyze an error in, e.g., identifying a voice command. A segment that would have been removed as PII may be important for such an analysis.

The first speech data 104 can be described by the first vector 105 of speaker-identifying characteristics (shown in FIG. 5). For the purposes of this disclosure, “speaker-identifying characteristics” are features of speech data that are specific to the speaker of that speech data, i.e., that are usable by a voice-identification algorithm to identify the speaker. The speaker-identifying characteristics can be the aspects of the first speech data 104 other than content (i.e., the basis of the text) and voice style (speaking loud or soft, fast or slow). The speaker-identifying characteristics may be represented as a first vector 105 that is an ordered list of numerical values, and the numerical values forming the first vector 105 can measure aspects of the first speech data 104 that can be used to identify the speaker, i.e., are the speaker-identifying characteristics provided in the first vector. For example, the numerical values may be mathematical functions of the first speech data 104, e.g., of a waveform of the first speech data 104, or the numerical values may result from applying a machine-learning algorithm to the first speech data 104, e.g., values from an intermediate or terminal layer of a neural network, e.g., as described below with respect to a first machine-learning program 122. For example, the first vector 105 can include a spectrogram 126. A spectrogram shows amplitude as a function of time and frequency. The spectrogram 126 can be a mel-spectrogram, i.e., a spectrogram with frequency measured according to the mel scale. The mel scale is a nonlinear transformation of the Hertz scale. The mel scale is generally better suited for analyzing speech than the Hertz scale.

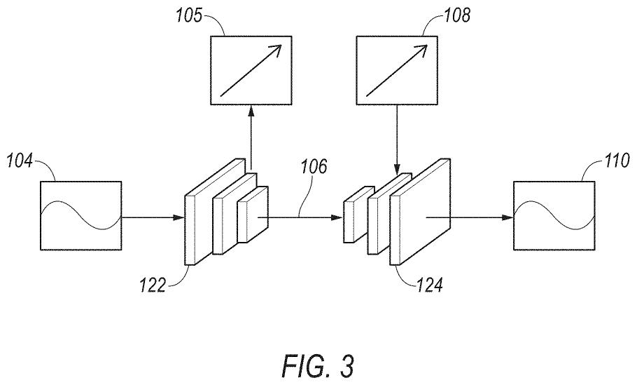

With reference to FIG. 3, the computer 102 can be programmed to remove the first vector 105 from the (redacted) first speech data 104 to generate extracted first speech data 106. Removing the first vector 105 from the first speech data 104 can include encoding the first speech data 104 without the first vector 105 as the extracted first speech data 106. In other words, the extracted first speech data 106 is an encoding of data from the first speech data 104 other than the first vector 105. The extracted first speech data 106 can include the content and the voice style of the first speech data 104 without the speaker-identifying characteristics. The extracted first speech data 106 may therefore not actually be speech data because the extracted first speech data 106 may not be playable as audio (unlike the redacted or unredacted first speech data 104 and the second speech data 110).

For example, encoding the first speech data 104 without the first vector 105 can include executing the first machine-learning program 122. The first speech data 104 can be processed using fast Fourier transform (FFT) before executing the first machine-learning program 122, FFT can be used as an intermediate step in the first machine-learning program 122, and/or the extracted first speech data 106 can be processed using FFT after executing the first machine-learning program 122. The first machine-learning program 122 can be, e.g., a convolutional neural network (CNN) using downsampling. A CNN with downsampling can be suitable for detecting the content and voice style while simplifying the first speech data 104 by removing the first vector 105 to arrive at the extracted first speech data 106. The first machine-learning program 122 can be jointly trained with a second machine-learning program 124 (described below) using sample speech data from multiple speakers in an unsupervised manner. The sample speech data from different speakers can have different, unrelated content. The joint training can include consecutively executing the first machine-learning program 122 and the second machine-learning program 124, with the second machine-learning program taking the output of the first machine-learning program 122 as input, and with the training depending on the output of the second machine-learning program 124. The first and second machine-learning programs 122, 124 can be trained on a series of paired sample speakers by swapping the respective first vectors of the speech data of the two speakers so that the outputs are speech data with the content and style of one of the speakers and the speaker-identifying characteristics of the other speaker. The training can minimize a loss function that depends in part on how well the original sample speech data can be reconstructed from the output of the second machine-learning program 124.

The computer 102 can be programmed to generate the random vector 108 of the speaker-identifying characteristics. Generating the random vector 108 can include sampling from distributions of the speaker-identifying characteristics, e.g., from amplitudes at different frequencies of the mel-spectrogram. The distributions can be derived from measurements of the speaker-identifying characteristics from a population of speakers. For example, the population of speakers can be recorded saying one or more preset phrases, the recordings can be converted to mel-spectrograms, and the distributions can be taken over the mel-spectrograms.

The computer 102 can be programmed to generate the random vector 108 before receiving the first speech data 104. For example, the computer 102 can be programmed to generate the random vector 108 once and store the random vector 108 in memory. For another example, the computer 102 can be programmed to generate the random vector 108 at the beginning of each vehicle 100 trip, e.g., in response to starting the vehicle 100. Alternatively, the computer 102 can be programmed to generate the random vector 108 independently for each generation of the second speech data 110 after receiving the first speech data 104.

The computer 102 can be programmed to generate the second speech data 110 by applying the random vector 108 to the extracted first speech data 106. Generating the second speech data 110 can include decoding the extracted first speech data 106 outputted by the first machine-learning program 122. In other words, the second speech data 110 is a decoding of the extracted first speech data 106 with the random vector 108. The second speech data 110 can include the (redacted) contents and voice style from the first speech data 104 combined with the speaker-identifying characteristics supplied by the random vector 108 rather than the first vector 105. The second speech data 110 may therefore not be usable for identifying the speaker, but the second speech data 110 is still speech data that can be played and understood, making the second speech data 110 useful for analysis.

For example, decoding the extracted first speech data 106 can include executing the second machine-learning program 124. The second machine-learning program 124 can be, e.g., a convolutional neural network (CNN) using upsampling. A CNN with upsampling can be suitable for combining the contents and voice style of the extracted first speech data 106 with the random vector 108 of the speaker-identifying characteristics. The second machine-learning program 124 in effect reverses the operations of the first machine-learning program 122. The second machine-learning program 124 can be jointly trained with the first machine-learning program 122 as described above.

The computer 102 can be programmed to remove metadata from the second speech data 110. The metadata can include, e.g., a vehicle identification number (VIN) and/or another source identifier.

The computer 102 can be programmed to transmit the second speech data 110 to the remote server 120, e.g., via the transceiver 118. For example, the computer 102 can be programmed to transmit the second speech data 110 upon generating the second speech data 110, or the computer 102 can be programmed to transmit the second speech data 110 from multiple generations, e.g., the second speech data 110 generated over a trip of the vehicle 100, as a batch.

The computer 102 can be programmed to transmit the random vector 108 to the remote server 120. The computer 102 can transmit the random vector 108 together with the second speech data 110 in a single message or in a separate message from the second speech data 110. Transmitting the random vector 108 in a separate message can help enhance security of data that may include PII. Regardless of whether the random vector 108 was transmitted in the same or a separate message from the second speech data 110, the remote server 120 can separately store the random vector 108 and the second speech data 110 to help enhance privacy.

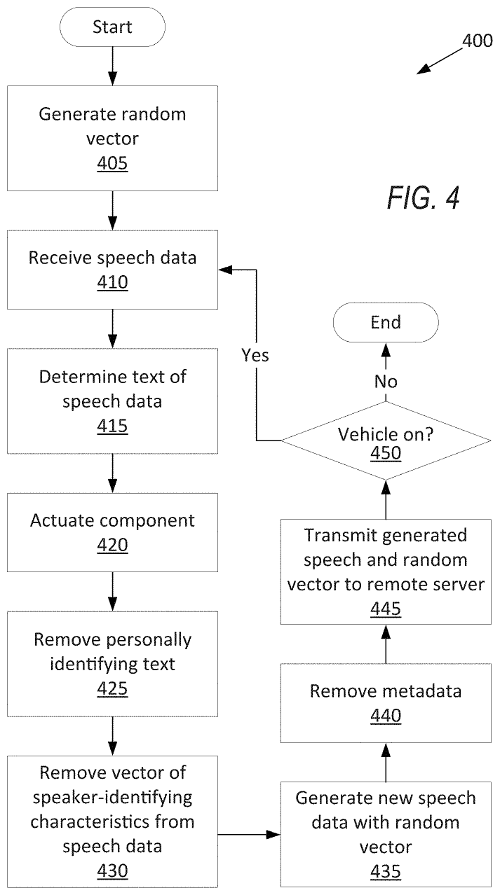

FIG. 4 is a process flow diagram illustrating an exemplary process 400 for anonymizing the first speech data 104 by generating the second speech data 110. The memory of the computer 102 stores executable instructions for performing the steps of the process 400 and/or programming can be implemented in structures such as mentioned above. The computer 102 can initiate the process 400 in response to the vehicle 100 being turned on. As a general overview of the process 400, the computer 102 generates the random vector 108. For as long as the vehicle 100 remains on, the computer 102 repeatedly receives the first speech data 104, determines the text of the first speech data 104, actuates the component 116 according to the voice command in the first speech data 104, removes the segments of the first speech data 104 having text in the category, removes the first vector 105 from the first speech data 104 to generate the extracted first speech data 106, generates the second speech data 110 from the extracted first speech data 106, removes the metadata from the second speech data 110, and transmits the second speech data 110 and the random vector 108 to the remote server 120.

The process 400 begins in a block 405, in which the computer 102 generates the random vector 108 for the speaker-identifying characteristics, as described above.

Next, in a block 410, the computer 102 receives the first speech data 104, as described above.

Next, in a block 415, the computer 102 determines the text from the first speech data 104, as described above.

Next, in a block 420, the computer 102 actuates the component 116 based on the voice command, e.g., as recognized from the text determined in the block 315, as described above.

Next, in a block 425, the computer 102 removes the segments of the first speech data 104 based on the text of the segments being in the category, e.g., being PII, as described above.

Next, in a block 430, the computer 102 removes the first vector 105 of the speaker-identifying characteristics from the first speech data 104 to generate the extracted first speech data 106, as described above.

Next, in a block 435, the computer 102 generates the second speech data 110 by applying the random vector 108 to the extracted first speech data 106, as described above.

Next, in a block 440, the computer 102 removes the metadata from the second speech data 110, as described above.

Next, in a block 445, the computer 102 transmits the second speech and the random vector 108 to the remote server 120, as described above.

Next, in a decision block 450, the computer 102 determines whether the vehicle 100 is still on. If the vehicle 100 is on, the process 400 returns to the block 410 to continue receiving the first speech data 104. If the vehicle 100 has been turned off, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device. The foregoing description may be performed by one or more of the foregoing computing devices.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity. Use of “in response to,” “upon determining,” etc. indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer comprising a processor and a memory, the memory storing instructions executable by the processor to:
receive first speech data;
remove a first vector of speaker-identifying characteristics from the first speech data to generate extracted first speech data;
generate a random vector of the speaker-identifying characteristics; and
generate second speech data by applying the random vector to the extracted first speech data.

2. The computer of claim 1, wherein the instructions further include instructions to determine text from the first speech data.

3. The computer of claim 2, wherein the instructions further include instructions to remove at least one segment of the first speech data based on the text of the at least one segment being in a category.

4. The computer of claim 3, wherein generating the second speech data occurs after removing the at least one segment of the first speech data.

5. The computer of claim 3, wherein the category is personally identifiable information.

6. The computer of claim 1, wherein the instructions further include instructions to transmit the second speech data to a remote server.

7. The computer of claim 6, wherein the instructions further include instructions to transmit the random vector to the remote server.

8. The computer of claim 1, wherein the first speech data includes a voice command.

9. The computer of claim 8, wherein the instructions further include instructions to actuate a component of a vehicle based on the voice command.

10. The computer of claim 1, wherein generating the random vector includes sampling from distributions of the speaker-identifying characteristics.

11. The computer of claim 10, wherein the distributions are derived from measurements of the speaker-identifying characteristics from a population of speakers.

12. The computer of claim 1, wherein the first vector includes a spectrogram.

13. The computer of claim 12, wherein the spectrogram is a mel-spectrogram.

14. The computer of claim 1, wherein removing the first vector from the first speech data includes encoding the first speech data without the first vector to generate the extracted first speech data.

15. The computer of claim 14, wherein encoding the first speech data without the first vector includes executing a machine-learning program.

16. The computer of claim 15, wherein the machine-learning program is a convolutional neural network using downsampling.

17. The computer of claim 14, wherein applying the random vector to the extracted first speech data includes decoding the extracted first speech data using the random vector.

18. The computer of claim 17, wherein decoding the extracted first speech data includes executing a machine-learning program.

19. The computer of claim 18, wherein the machine-learning program is a convolutional neural network using upsampling.

20. A method comprising:
receiving first speech data;
removing a first vector of speaker-identifying characteristics from the first speech data to generate extracted first speech data;
generating a random vector of the speaker-identifying characteristics; and
generating second speech data by applying the random vector to the extracted first speech data.
